(19) United States
(12) Patent Application Publication
(10) Pub. No.: US 2026/0238559 A1
(43) Pub. Date: Aug. 13, 2026

(54) METHODS AND APPARATUS FOR BEAM SELECTION

(71) Applicant: TELEFONAKTIEBOLAGET LM ERICSSON (PUBL), Stockholm (SE)

(72) Inventors: Konstantinos VANDIKAS, Solna (SE); Sabrine AROUA, Antony (FR); Alexandros NIKOU, Danderyd (SE); Athanasios KARAPANTELAKIS, Solna (SE); Wenfeng HU, TÄBY (SE)

(73) Assignee: TELEFONAKTIEBOLAGET LM ERICSSON (PUBL), Stockholm (SE)

(21) Appl. No.: 19/470,656

(22) PCT Filed: Jul. 5, 2023
(86) PCT No.: PCT/SE2023/050700

§ 371 Date: Sep. 29, 2025

(30) Foreign Application Priority Data
Mar. 31, 2023 (GR) 20230100274

(51) Int. Cl. H04L 41/16; H04B 7/06

(52) U.S. Cl. CPC H04L 41/16; H04B 7/06952

(57) ABSTRACT

A ML method for beam selection in a communication network. The method comprises transmitting, by the first network node to the controller, a first network node data set and transmitting, by the second network node to the controller, a second network node data. The method further comprises training, by the controller, a ML model using the first network node data set and the second network node data set in conjunction and generating, by the controller, a policy using the ML model based on a global reward function, The method further comprises transmitting, by the controller to the first network node and the second network node, the policy and controlling by the first and second network nodes beam selection based on the policy.

### TECHNICAL FIELD

Embodiments of the present disclosure relate to methods and apparatus in communication networks, and particularly methods and apparatus for beam selection in communication networks.

### BACKGROUND

Fifth-Generation (5G) New Radio (NR) cellular networks and Institute of Electrical and Electronic Engineers (IEEE) standard 802.11ac compliant (WiFi) networks may rely on beam-based cell coverage to increase network efficiency. For example, beam-based cell coverage may be used to increase the link budget and overcome disadvantages of millimetre wave (mmWave) channels such as the high cost and power consumption of mmWave mixed-circuit components. The use of beam-based cell coverage may require beam management techniques which are used to sweep an area and discover user equipments (UEs) that can successfully use these beams to connect to the cellular network.

FIG. 1 depicts an overview of a network implementing beam-based cell coverage. The figure shows two network nodes, gNB₁ 11 and gNB₂ 12, and a UE 10. Each of the two network nodes gNB₁ 11 and gNB₂ 12 comprises multiple transmission/reception points (TRPs) and transmits multiple beams. Although a single beam is depicted from each of gNB₁ 11 and gNB₂ 12 as reaching the UE 10, each of the network nodes will transmit multiple beams at a range of angles. The UE 10 will then acknowledge (or not acknowledge) the beams received from each gNB 11/12. The UE 10 may receive two beams each from different gNBs 11/12, which can be useful in a carrier aggregation context.

In an example existing 5G NR network, a synchronization signal (SS) burst may be used for beam management. For example, the SS burst may be produced by a network node (gNB) every 5 ms. The SS burst may contain different SS blocks (SSBs), where each SSB is designed for or associated with a specific direction. The number of SSBs is dependent on the frequency of the SS burst. For example, for a SS burst under 3 GHz there are typically 4 SSBs which describe four wide beams, and for higher frequencies up to 64 SSBs can be included in the burst for different beams or directions.

A UE that receives one (or more) such SSBs may use them to measure the channel associated with the SSB(s). If the UE is in IDLE mode or if the UE is already connected, it may use Channel State Information-Reference Signal (CRI-RS) in downlink (DL) or Sounding Reference Signal (SRS) in uplink (UL). This may be known as the beam determination step or the beam measurement step.

After the beam measurement step, the UE will begin the beam reporting step. During the beam reporting step, the UE may report back to the gNB by transmitting in the UL a Random Access Channel (RACH) preamble. The UE may also sent a Physical Random Access Channel (PRACH) preamble in the UL which corresponds to the DL SS Block that has the best signal strength. The UL SS block may have a 1 to 1 correspondence with the DL SS block.

### SUMMARY

It is an object of the present disclosure to facilitate beam selection in communication networks.

Embodiments of the disclosure aim to provide apparatuses and methods that alleviate some or all of the problems identified.

An embodiment of the disclosure provides a ML method for beam selection in a communication network. The communication network comprises a first network node, a second network node, and a controller. The method comprises transmitting, by the first network node to the controller, a first network node data set, wherein the first network node data set comprises at least an initial first network node state, a resulting first network node state, a first network node action, and a first network node reward function. The method further comprises transmitting, by the second network node to the controller, a second network node data set, wherein the second network node data set comprises at least an initial second network node state, a resulting second network node state, a second network node action, and a second network node reward function. The method further comprises training, by the controller, a ML model using the first network node data set and the second network node data set in conjunction and generating, by the controller, a policy using the ML model based on a global reward function, wherein the global reward function is configured to increase overall beam selection efficiency across the first network node and the second network node. The method further comprises transmitting, by the controller to the first network node and the second network node, the policy, controlling by the first network node a first beam selection based on the policy, and controlling by the second network node a second beam selection based on the policy.

A further embodiment of the disclosure provides a controller for beam selection in a communication network. The controller comprises processing circuitry and a non-transitory machine-readable medium storing instructions. The controller is configured to receive, from a first network node, a first network node data set, wherein the first network node data set comprises at least an initial first network node state, a resulting first network node state, a first network node action, and a first network node reward function. The controller is further configured to receive, from a second network node, a second network node data set, wherein the second network node data set comprises at least an initial second network node state, a resulting second network node state, a second network node action, and a second network node reward function. The controller is further configured to train a ML model using the first network node data set and the second network node data set in conjunction and generate a policy using the ML model based on a global reward function, wherein the global reward function is configured to increase overall beam selection efficiency across the first network node and the second network node. The controller is further configured to transmit, to the first network node and the second network node, the policy.

A further embodiment of the disclosure provides a communication network comprising the controller, and additionally comprising a first network node and a second network node, wherein the first network node is configured to control a first beam selection based on the policy and the second network node is configured to control a second beam selection based on the policy.

Further embodiments provide methods, controllers, network nodes and systems as discussed herein.

Advantageously, the embodiments enable two or more gNBs that monitor an overlapping area may collaboratively learn the most efficient range of beams to serve to different UEs. Thus, two or more gNBs that monitor an overlapping area may further collaboratively learn the most efficient range of beams to serve to different UEs at different stages and/or times of the beam selection process.

### BRIEF DESCRIPTION OF DRAWINGS

For a better understanding of the present disclosure, and to show how it may be put into effect, reference will now be made, by way of example only, to the accompanying drawings, in which:

FIG. 1 is a diagram presenting an overview of a network implementing beam-based cell coverage;

FIG. 2 is a schematic diagram of a RL system;

FIG. 3 is a flowchart of a method for beam selection in a communication network, in accordance with embodiments;

FIG. 4 is a schematic diagram of a network, in accordance with embodiments;

FIG. 5A and FIG. 5B (collectively referred to as FIG. 5) are schematic diagrams of controllers, in accordance with embodiments;

FIG. 6A and FIG. 6B (collectively referred to as FIG. 6) are schematic diagrams of radio nodes, in accordance with embodiments;

FIG. 7 is a further diagram presenting an overview of a network, in accordance with embodiments;

FIG. 8 is a diagram presenting specific beam selection methods, in accordance with embodiments;

FIG. 9 is a sequence diagram of the method of embodiments.

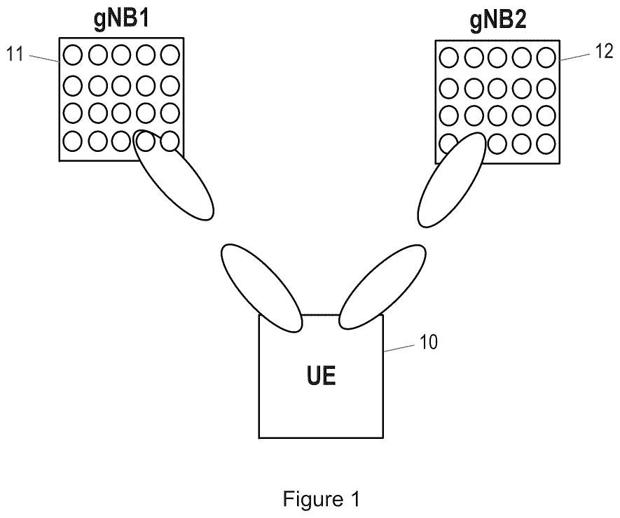

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

In a network implementing beam-based cell coverage, a challenge may be finding the right beam. Mitigating the challenges of beam selection may be done using data driven control. However, data driven control of complex interconnected systems, such as communications networks implementing beam-based cell coverage, is a complex challenge. In order to meet this challenge machine learning (ML) techniques such as reinforcement learning (RL) that enable effectiveness and adaptiveness may be utilised.

RL allows a Machine Learning System (MLS) to learn by attempting to maximise an expected cumulative reward for a series of actions utilising trial-and-error. This series of actions may be dictated by a policy. RL critics (that is, a system which uses RL in order to improve performance in a given task over time) are typically closely linked to the system or actors (forming an environment) they are being used to model/control, and learn through experiences of performing actions that alter the state of the environment.

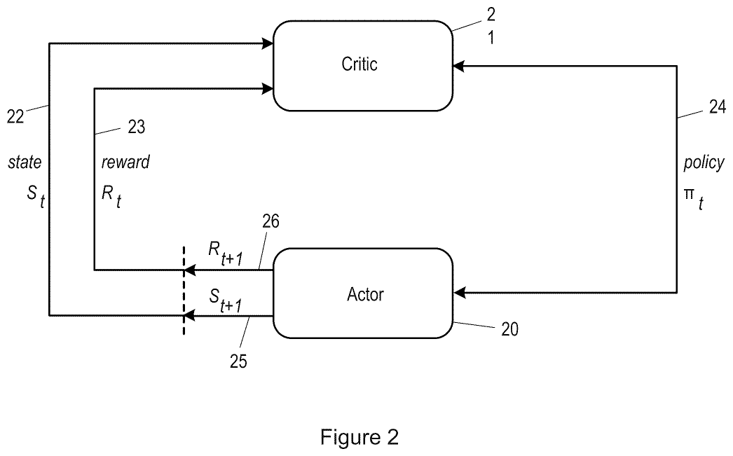

FIG. 2 illustrates schematically a typical RL system. In the architecture shown in FIG. 2, a critic 21 (which in embodiments may be, or may be implemented by, a controller) receives data from, and transmits policies to, the actor 20 or network node which it is being used to model/control. For a time t, the critic 21 receives information on a current state of the environment Sₜ 22 from the actor. The critic 21 then processes the information Sₜ, and generates one or more policies 24 for the actor to implement; one of these policies is to be implemented πₜ. The policy IT may affect the actions taken by the actor during the time that the policy is implemented. The policy πₜ to be implemented is then transmitted back to the actor 20 and put into effect. The result of the policy πₜ is a change in the state of the environment with time, so at time t+1 the state of environment is Sₜ₊₁. The policy also results in a (numerical, typically scalar) reward Rₜ₊₁, which is a measure of effect of the policy TT resulting in environment state Sₜ₊₁. The changed state of the environment Sₜ₊₁ 25 is then transmitted from the actor to the critic, along with the reward Rₜ₊₁ 26. FIG. 2 shows reward Rₜ being sent to the critic together with state Sₜ 23; reward Rₜ is the reward resulting from policy πₜ₋₁, performed on state Sₜ₋₁. When the critic receives state information Sₜ₊₁ this information is then processed in conjunction with reward Rₜ₊₁ in order to determine the next policy πₜ₊₁, and so on. The policy to be implemented is selected by the critic from policies available to the critic with the aim of maximising the cumulative reward. RL can provide a powerful solution for dealing with the problem of adjusting data validation models without undue recourse to human expert input.

In existing communication networks implementing beam-based cell coverage, machine learning-based approaches have been developed that avoid sending all SSBs during the selection process for the best beam by leaning to predict which SSBs are the most likely to be captured by the UE without the UE requesting any failure recoveries. “Reinforcement Learning for Beam Pattern Design in Millimetre Wave and Massive MIMO Systems” by Yu Zhang et al. discloses a method of beam management based on Reinforcement Learning (RL) Machine Learning (ML) but only with consideration of a single actor or network node without considering any neighbouring gNB choices. This method therefore does not consider the complexities of a multi-actor system. This method also proposes considering an action space that treats the angle of the beam (O) as a continuous space and choosing one single value at a time in order to calculate an optimum angle of transmission for the UE such that a beam can be selected based on the optimum angle.

Known approaches only consider beam selection from the perspective of a single gNB as a host of multiple MIMO antennas and multiple TRPs and not as a collaborative problem between two or more gNBs that are covering a similar area. Thus, in known approaches a gNB may be serving an SS block to a UE that already has one from another gNB. In addition, a UE that benefits from two SS blocks coming from two gNBs might not receive one of those beams in a timely manner and thus may select a less optimal block, and one of the gNBs may be wasting resources by serving irrelevant SSBs that the UE does not select. These limitations may contribute to reduced efficiency in known approaches.

The following sets forth specific details, such as particular embodiments for purposes of explanation and not limitation. It will be appreciated by one skilled in the art that other embodiments may be employed apart from these specific details. In some instances, detailed descriptions of well-known methods, nodes, interfaces, circuits, and devices are omitted so as to not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

To overcome the problems detailed previously, the present invention provides a multi-network node or multi-actor based RL based approach which may enable collaborative setup. That is, two or more gNBs that monitor an overlapping area may collaboratively learn the most efficient range of beams to serve to different UEs. Two or more gNBs that monitor an overlapping area may further collaboratively learn the most efficient range of beams to serve to different UEs at different stages and/or times of the beam selection process. Embodiments formalize the problem to a multi-actor or multi-node setup with multiple network nodes and a single controller. Accordingly, a set of network nodes may learn to modify the range of SSBs for a given point in time based on the actions of other gNBs (or other actors of other types) to maximise a global reward spanning all related gNBs and any actor-controlled gNBs as determined by the central controller.

In embodiments, the communication network may comprise a central controller or central critic. The critic may be implemented or housed by a controller. The communication network may further comprise a number of network nodes, which may otherwise be referred to as agents or actors. Each of the actors may be implemented or housed by one of a plurality of network nodes.

Embodiments are described using an example network comprising two gNBs collaborating in the process of selecting which beams to serve. However, it will be appreciated by one skilled in the art that other embodiments may be employed apart from these specific details. In some instances, the same collaborative process can be formulated from the perspective of two or more Multiple-Input Multiple-Output (MIMO) antennas or two or more Transmission-Reception points (TRPs) in the same or neighbouring gNBs. Further, the same collaborative process can be formulated from the perspective of a plurality of gNBs, for example more than two gNBs, or a plurality of UEs.

Embodiments may provide the technical advantage of improved efficiency of network operation, for example by saving energy by reducing the number of beams served to the UE. This effect may be compounded because it is not limited to a single gNB but also impacts neighbouring gNBs. Moreover, similar energy saving effects may be observed at the UE since the UE no longer needs to measure unnecessary beams. Embodiments may also be inherently backwards compatible with older networks, as each network node may be capable of resetting its beam selection, or falling back to serving all beams, in the case where methods of the embodiments are not supported by the network.

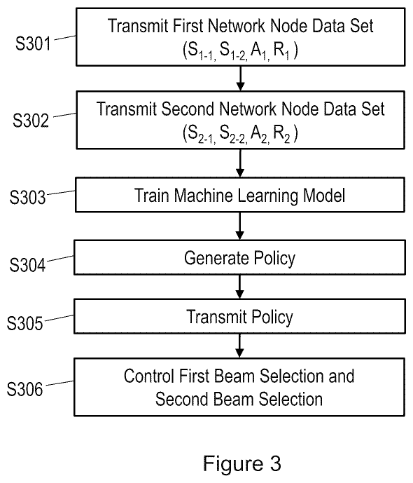

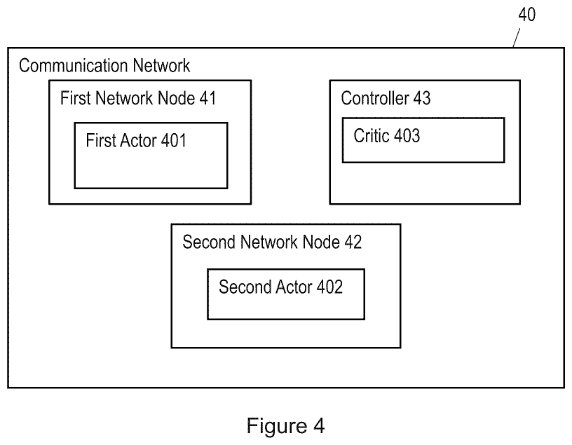

A method implemented by a network in accordance with embodiments is illustrated in FIG. 3, which is a flowchart showing a method for beam selection. The method may be performed by any suitable apparatus, for example, by a communications network 40 such as that depicted in FIG. 4. For example, the communications network may be a 5G network as discussed above, and the network node may be a gNB. As an alternative example, the communications network may be a IEEE standard 802.11ac compliant network (such as a WiFi network), and the network nodes may be IEEE standard 802.11ac compliant connectivity nodes (such as WiFi nodes).

As depicted in FIG. 4, the communication network 40 may comprise a first network node 41, a second network node 42, and a controller 43. A first actor 401 may be implemented on the first network node 41, that is the first network node 41 may comprise the first actor 401 and additional functionality. Alternatively, the first network node 41 may be considered to be the first actor 401. A second actor 402 may implemented on the second network node 42, that is the second network node 42 may comprise the second actor 402 and additional functionality. Alternatively, the second network node 42 may be considered to be the second actor 402. A critic 403 may be implemented on the controller 43, that is the controller 43 may comprise the critic 403 and additional functionality. Alternatively, the controller 43 may be considered to be the critic 403.

The controller 43 is common for the first network node 41 and second network node 42, as shown in FIG. 4. In a more generalised case, the controller or critic will be common for all network nodes or actors. In the case where each actor is implemented on a network node, the actor will be specific to the network node on which it is implemented.

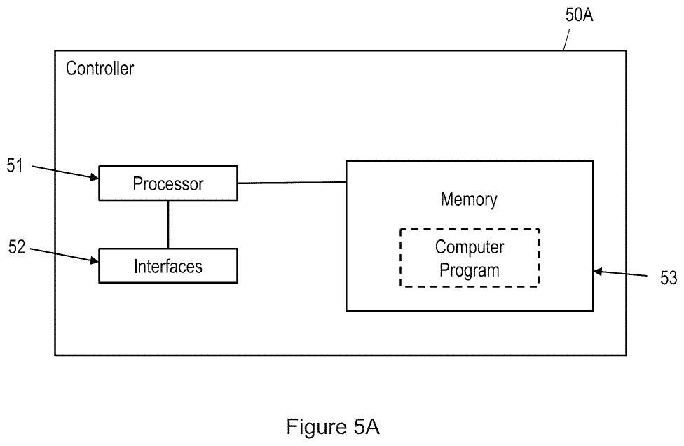

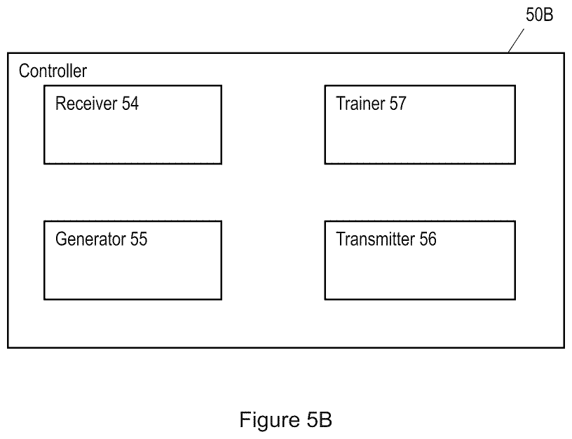

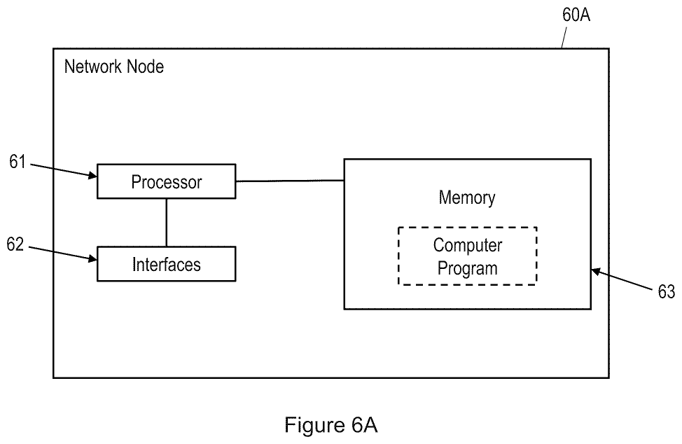

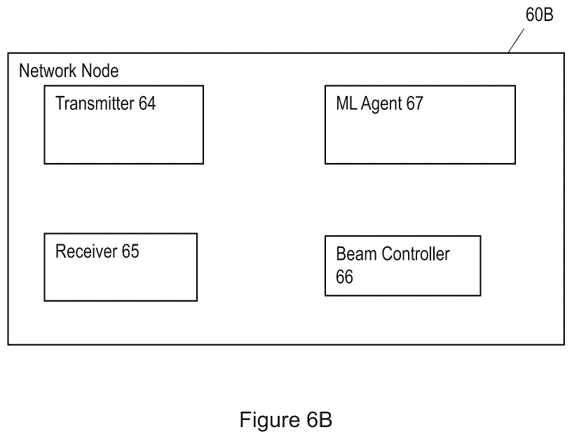

The steps performed by each network node of the communication network may be performed in accordance with a computer program stored in a memory 63, executed by a processor 61 in conjunction with one or more interfaces 62 of the network node 60A, as illustrated by FIG. 6A. Similarly, the steps performed by the controller of the communication network may be performed in accordance with a computer program stored in a memory 53, executed by a processor 51 in conjunction with one or more interfaces 52 of the controller 50A, as illustrated by FIG. 5A.

FIG. 5B depicts a controller 50B configured to perform the relevant steps of the embodiments. Controller 50B may include a receiver 54, generator 55, transmitter 56 and trainer 57 as depicted in FIG. 5B.

FIG. 6B depicts a network node 60B configured to perform the relevant steps of the embodiments. The network node 60B may be either the first network node or the second network node of the embodiments, or any other network node in the embodiments where more than two network nodes are present. Network node 60B may include a transmitter 64, a receiver 65, an ML agent 67 and a beam controller 66 as depicted in FIG. 6B.

As shown in step S301 of FIG. 3, the method of embodiments comprises transmitting a first network node data set from the first network node 41 to the controller 43. The first network node data set may comprise at least an initial first network node state (S₁₋₁), a resulting first network node state (S₁₋₂), a first network node action (A₁), and a first network node reward function (R₁). The first network node state may encompass any relevant variable of the first network node 41 at any point in time. By way of example, the first network node state may include any variable that may be used to monitor the first network node 41, such as the number of UEs connected to the first network node 41, an indication of the energy consumption or energy budget of the first network node 41, the number of active antennas of the first network node 41 and/or positions of the same, the number and/or position of any network nodes connected to the first network node 41, measurements of incoming/outgoing data for the first network node 41, latency measurements, measurements of dropped packets, and so on. In some embodiments, the first network node state may be directly obtained by the first network node 41 before being transmitted to the controller 43. Where the first network node state is not directly obtained by the first network node 41, the first network node state may be obtained using any suitable form of wired or wireless communication, or combination of wired and wireless communication. The step of obtaining the first network node state may be performed in accordance with a computer program stored in a memory 63, executed by a processor 61 in conjunction with one or more interfaces 62 of the first network node 60A, as illustrated by FIG. 6A. Alternatively, the step of obtaining the first data values may be performed by receiver 65 of the first network node 60B as shown in FIG. 6B. The step of transmitting the first network node state may be performed by the transmitter 64 of the first network node 60B as illustrated in FIG. 6B. The step of receiving the first network node state may be performed by the receiver 54 of the controller 50B as illustrated in FIG. 5B. Alternatively or additionally, the first network node 60B may transmit a representation of the first network node state, for example compressing the first network node state information into a lower dimension.

As shown in step S302 of FIG. 3, the method of embodiments comprises transmitting, a second network node data set from the second network node 42 to the controller 43. The second network node data set may comprise at least an initial second network node state (S₂₋₁), a resulting second network node state (S₂₋₂), a second network node action (A₂), and a first network node reward function (R₂). In a manner analogous to the first network node state, the second network node state may encompass any relevant variable of the second network node 42 at any point in time. By way of example, the second network node state may include any variable that may be used to monitor the second network node 42, such as the number of UEs connected to the second network node 42, an indication of the energy consumption or energy budget of the second network node 42, the number of active antennas of the first network node 42 and/or positions of the same, the number and/or position of any network nodes connected to the second network node 42, measurements of incoming/outgoing data for the second network node 42, latency measurements, measurements of dropped packets, and so on. In some embodiments, the second network node state may be directly obtained by the second network node 42 before being transmitted to the controller 43. Where the second network node state is not directly obtained by the second network node 42, the second network node state may be obtained using any suitable form of wired or wireless communication, or combination of wired and wireless communication. The step of obtaining the second network node state may be performed in accordance with a computer program stored in a memory 63, executed by a processor 61 in conjunction with one or more interfaces 62 of the second network node 60A, as illustrated by FIG. 6A. Alternatively, the step of obtaining the second data values may be performed by receiver 65 of the second network node 60B as shown in FIG. 6B. The step of transmitting the second network node state may be performed by the transmitter 64 of the second network node 60B as illustrated in FIG. 6B. The step of receiving the second network node state may be performed by the receiver 54 of the controller 50B as illustrated in FIG. 5B. Alternatively or additionally, the second network node 60B may transmit a representation of the second network node state, for example compressing the second network node state information into a lower dimension.

In a specific embodiment, the first network node may transmit a plurality of first network node data sets to the controller. Alternatively or additionally, the second network node may transmit a plurality of second network node data sets to the controller. In a further specific embodiment, the initial first network node state of each of the plurality of first network node data sets may correspond to the resulting first network node state of the following first network node data set. Alternatively or additionally, the initial second network node state of each of the plurality of second network node data sets may correspond to the resulting second network node state of the following second network node data set. For example, the plurality of first network node data sets may comprise 10 first network node data sets and the plurality of second network node data sets may comprise 10 second network node data sets.

As shown in Step S303 of FIG. 3, the method of embodiments comprises training, by the controller, a ML model using the first network node data set and the second network node data set in conjunction. In specific embodiments, the controller may train the ML model using reinforcement learning. Alternatively, the controller may train the ML model using an Alternating Direction Method of Multipliers, ADMM, optimization algorithm. Any suitable training method may be used. The step of training the ML model may be performed by the trainer 57 of the controller 50B as illustrated in FIG. 5B.

As shown in Step S304 of FIG. 3, the method of embodiments comprises generating, by the controller, a policy using the ML model based on a global reward function. The global reward function is configured to increase overall beam selection efficiency across the first network node and the second network node. The step of generating the policy may be performed by the generator 55 of the controller 50B as illustrated in FIG. 5B.

In embodiments, increasing overall beam selection efficiency may refer to one or more of: maximizing throughput, minimizing latency, reducing energy and/or resource consumption, and otherwise improving network performance.

In specific embodiments, training the ML model may include calculating a true action-value, which may be referred to as a Q-Value. The Q-Value comprises a first weighting function associated with the first network node and a second weighting function associated with the second network node. In a further specific embodiment, the first weighting function and/or the second weighting function may be associated with one or more of: the maximum number of UEs that can be connected to the respective network node, the number of active UEs connected to the respective network node, the number of dormant and/or idle UEs connected to the respective network node, and/or the number of inactive UEs connected to the respective network node.

Alternatively or additionally, the training of the ML model by the controller may include using the following loss function:

$$δ = R + γ u ( {S}^{′} , w ) - u ( S , w )$$

where δ is the loss function for the communication network, R is the reward function for the communication network, S is an initial state of the communication network, S′ is a resulting state of the communication network, u(S,w) is the estimation of the Q-value for state S, γ is a weighting function, and w are the parameters used to quantify S.

In a further specific embodiment, each of the first and second network node data sets may comprise a time stamp. The training of the ML model by the controller may comprise training a first ML model associated with a first time stamp to generate a first policy, and training a second ML model associated with a second time stamp to generate a second policy. In such embodiments, the first and second network nodes are therefore able to implement different policies on a periodic basis (for example, at different times of day/week/month/year and so on). As an example of the use of different policies, the network nodes may implement a first policy during a time of day with higher levels of traffic (such as a morning commute period), and may implement a second policy during a time of day with lower levels of traffic (such as in the night).

In embodiments where different policies are used at different times of day, the method may further comprise storing, by the first network node and the second network node, the first policy and the second policy. The method may also further comprise controlling, by the first network node and the second network node, the first and second beam selection respectively using the first policy and the second policy in accordance with the time stamps of the first policy and the second policy.

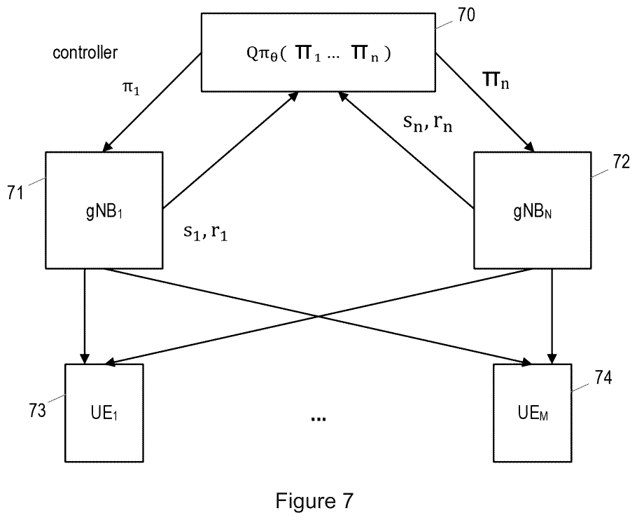

The first and second network nodes may implement different policies to one another at the same time, as depicted in FIG. 7. Accordingly, the training of the ML model by the controller may comprise training a ML model associated with a first time stamp to generate a first policy for each network node, and training a second ML model associated with a second time stamp to generate a second policy for each network node. The first and second network nodes may then store their respective first and second policies, and control their respective beam selections using their respective policies in accordance with the time stamps of their respective policies.

The first and second network nodes may implement different policies to one another at the same time due to differing capacity requirements between the network nodes. For example, the first network node may be operating in a high traffic area and the second network node may be operating in a low traffic area or vice versa. Accordingly, the first and second network nodes may implement policies that are best suited to their capacity requirements and provide the best overall network efficiency.

As shown in Step S305 of FIG. 3, the method of some embodiments comprises transmitting the policy from the controller to the first network node and second network node. The step of transmitting the policy may be performed by the transmitter 56 of the controller 50B as illustrated in FIG. 5B. The step of receiving the policy may be performed by receiver 65 of each network node 60B as shown in FIG. 6B.

FIG. 7 depicts the interactions between communication network components in embodiments. FIG. 7 depicts the first network node gNB₁ 71 the nth network node gNBₙ 72 with the network comprising n network nodes. FIG. 7 also depicts the first UE (UE₁) 73 and the mth UE (UEₘ) 74 with the network comprising m UEs. FIG. 7 further depicts the controller 70 of the communication network. As previously discussed, the controller 70 is common to all network nodes; in specific embodiments, the controller may be a common controller for a set of network nodes that cover a specific area.

Accordingly, in specific examples the controller 70 may therefore configured to estimate the true-action value or Q-value function for an action Aₜ given a state Sₜ while the network nodes 71/72 produce further actions (for example, action at time t+1, Aₜ₊₁) based on a policy generated by the controller. The controller estimates the true-action value by using input from all the network nodes for which it is the common controller; these inputs include the state of each of the network nodes and a reward function for the actions taken by each of the network nodes (S₁, R₁, . . . Sₙ, Rₙ). The controller then generates a policy for each of the network nodes (π₁ . . . πₙ) which the controller transmits to each of the network nodes.

As shown in Step S306 of FIG. 3, the method of embodiments comprises controlling by the first network node a first beam selection based on the policy, and controlling by the second network node a second beam selection based on the policy. This step may be performed by the beam controller 66 of each network node 60B as depicted in FIG. 6B. In specific embodiments, controlling the first beam selection by the first network node and/or controlling the second beam selection by the second network node comprises updating, by said network node, an upper bound and/or a lower bound of the range of the number of beams to be transmitted by said network node. In a further specific embodiment, updating the upper bound and/or lower bound of the range of the number of beams to be transmitted by said network node may comprise selecting one or more of the following actions: increasing the lower bound of a number of available beams, decreasing the lower bound of the number of available beams, increasing the upper bound of the number of available beams, decreasing the upper bound of the number of available beams, and/or falling back to the original upper and lower bounds of the number of available beams.

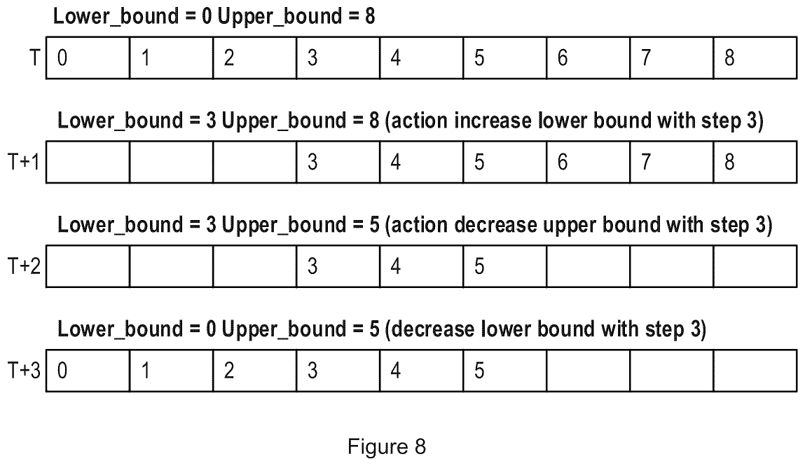

FIG. 8 depicts specific beam selection methods in accordance with specific embodiments. FIG. 8 shows an example of the range of available SSBs of a network node at times T, T+1, T+2, and T+3. Each network node may have an associated range of SSBs to transmit. This range may be defined as [lower_bound, upper_bound], where:
lower_bound is the lower bound of the range of the number of beams to be transmitted by said network node, and/or the lower bound of the available SSBs to be transmitted,
upper_bound is the upper bound of the range of the number of beams to be transmitted by said network node, and/or the upper bound of the available SSBs to be transmitted,
lower bound and upper bound both receive a value between 0 and the maximum number of SSBs of the network node, and
lower bound receives a value smaller than upper_bound.

A number of actions available to the network node in response to the policy are depicted in FIG. 8. For example, at time T+1 the network node takes the action of increasing the lower bound by 3 steps. At time T+2 the network node takes the action of decreasing the upper bound by 3 steps. At time T+3 the network node takes the action of decreasing the lower bound by 3 steps.

In addition to the policy, the first and second network nodes may train their own ML models for beam management. The step of training a local ML model for beam management by a network node may be performed by ML agent 67 of the respective network node 60B as shown in FIG. 6B. For example, in embodiments the method may further comprise training, by the first network node, a first network node ML model using the first network node data and training, by the second network node, a second network node ML model using the second network node data.

In specific examples, the training of each network node ML model by each respective network node may include the following equation:

$$x = mean ( - δ * log ( π ( α / s ) )$$

where x is a loss function for the respective network node, δ is the loss function for the communication network, α is the respective network node action, s is the respective network node state, π is a probability for the respective network node action α to occur when the respective network node is in the respective network node state s. In this case, the loss function for the respective network node uses the loss function for the critic to improve the overall efficiency of the network by selecting one of the different actions available to the network node.

Alternatively or additionally, the training of each network node ML model by each respective network node may include the calculation of a reward function. The reward function may be used by the network node to determine if one action is better than another action for a given state. The reward function may be discounted by a factor γ, which may allow the network node to select the action that yields the highest long-term reward rather than the action that yields the best reward for the next state.

The reward function may be:

$$R = \frac{C}{U - L}$$

wherein C is a number of UEs connected to said radio node, U is an upper bound of the range of the number of beams to be transmitted by said radio node, L is a lower bound of the range of the number of beams to be transmitted by said radio node, and R is the reward function. Alternatively or additionally, the reward function may include one or more of: a ratio of served traffic to requested traffic, and/or an aggregated power consumption figure of the first and second network nodes normalized against a nominal value.

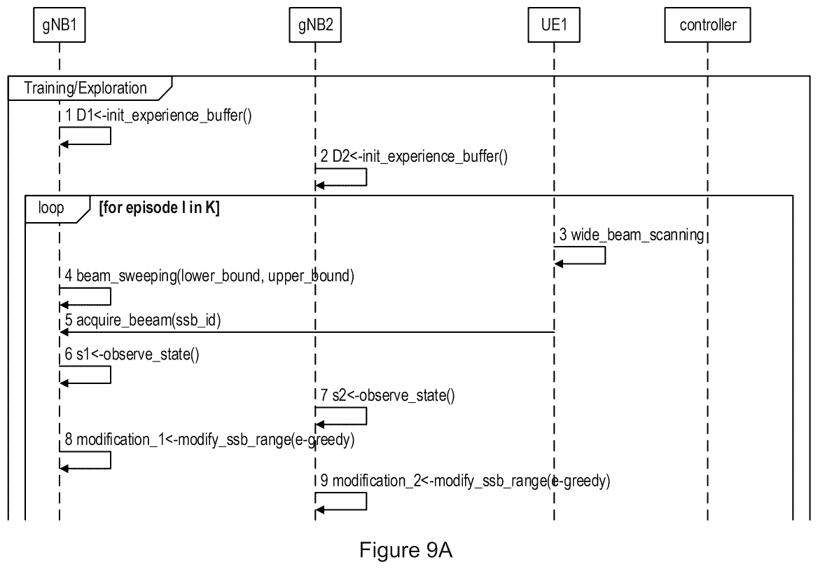

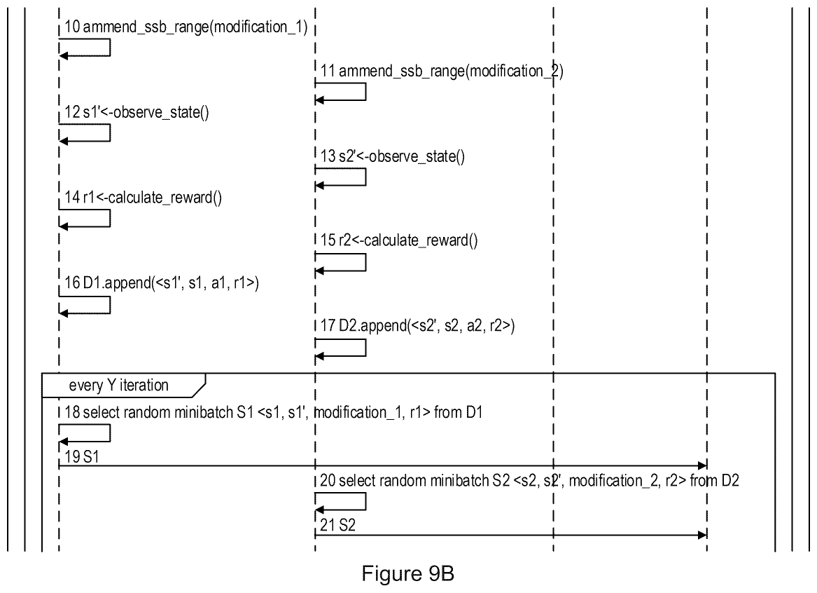

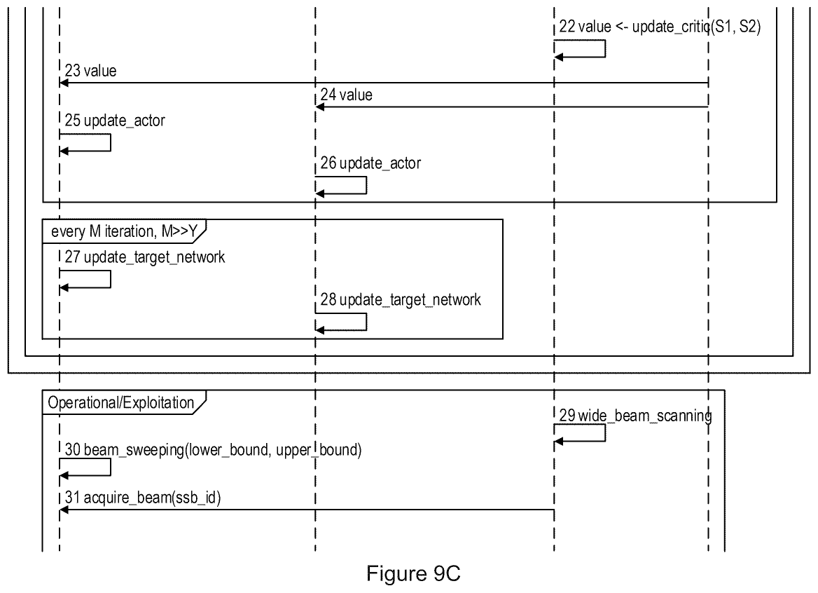

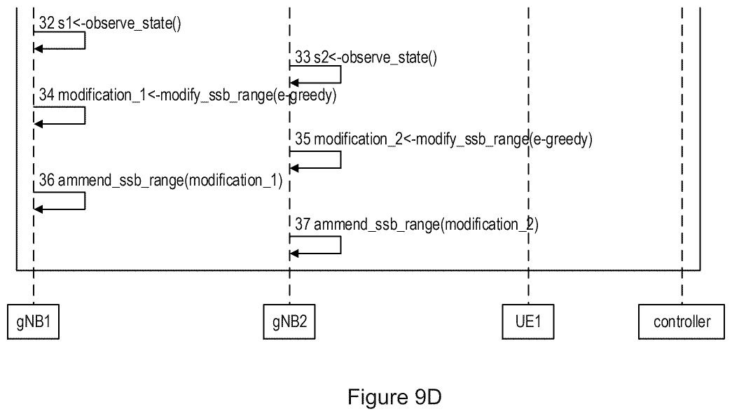

FIG. 9 (consisting of FIG. 9A, FIG. 9B, FIG. 9C and FIG. 9D) presents a sequence diagram of the method of embodiments. As shown in FIG. 9, the method beings with a training/exploration phase. During the training/exploration phase, every network node (gNB₁ and gNB₂) holds their respective buffers (D1, D2) where different experiences (combinations between state Sₙ, action Aₙ, next state Sₙ₊₁ and corresponding reward Rₙ) are recorded. During the training/exploration phase, every UE may be in a beam scanning phase and correspondingly every gNB in a beam sweeping phase which means that every gNB may be constantly iterating through an index of SBBs indexed between [lower_bound and upper_bound], sending those beams to the different UEs and receiving some acknowledgement when a UE acquire each beam.

The RL loop begins in the loop phase of FIG. 9; the loop phase starts with steps 6 and 7 of the sequence diagram where each network node observes it's state or any of the parameters previously detailed that could be considered as part of a given network node state. Given these input parameters every gNB select an action which is the action that yields the highest reward using the controller (and, in some embodiments, the local ML algorithm of the network node) as a mechanism to identify that. Based on the action the SSB lower and upper bound are amended, and beams are sent from the amended ranges.

As shown in FIG. 9, once the beams are sent from the amended ranges the state of each network node is observed again to identify for example how many UEs have been collected for the newly updated range and the experience is recorded. For every Y iterations, a subset of each set of experiences may be collected (as shown in steps 18 and 20) that may be used to train the common critic (as shown in step 22). The value or value function that is produced in step 22 may be used as the policy by each network node when they determine which action to pick next. Using this input in steps 25 and 26, every network node may be retrained to better approximate the action that yield the highest reward based on the common controller output (or value).

In some embodiments, the steps of the method may be repeated to form an iterative ML method. The iterative ML method may ended when ML model reaches a stable state. This is depicted in steps 29 to 37 of FIG. 9, which takes place after M iterations where M>>Y. These steps are similar to the steps in the exploration phase with the main exception that now the agents are no longer trained but instead the underlying models for the network nodes and controller have both converged to yield high rewards therefore it is no longer necessary to collect new experiences or re-train these models.

In some embodiments, the communication network may be a fifth generation, 5G, new radio, NR, network and the network nodes are radio nodes. Alternatively, the communication network may be an IEEE standard 802.11ac (WiFi) compliant network and the network nodes are IEEE standard 802.11ac compliant (WiFi) connectivity nodes.

It will be appreciated that examples of the present disclosure may be virtualised, such that the methods and processes described herein may be run in a cloud environment.

Advantageously, the embodiments enable two or more gNBs that monitor an overlapping area may collaboratively learn the most efficient range of beams to serve to different UEs. Thus, two or more gNBs that monitor an overlapping area may further collaboratively learn the most efficient range of beams to serve to different UEs at different stages and/or times of the beam selection process.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some embodiments may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1-25. (canceled)

26. A controller for a communication network, the controller comprising processing circuitry and a non-transitory machine-readable medium storing instructions, wherein the controller is configured to:
receive, from a first network node, a first network node data set, wherein the first network node data set comprises at least an initial first network node state (S₁₋₁), a resulting first network node state (S₁₋₂), a first network node action (A₁), and a first network node reward function (R₁);
receive, from a second network node, a second network node data set, wherein the second network node data set comprises at least an initial second network node state (S₂₋₁), a resulting second network node state (S₂₋₂), a second network node action (A₂), and a second network node reward function (R₂);
train a ML model using the first network node data set and the second network node data set in conjunction;
generate a policy using the ML model based on a global reward function, wherein the global reward function is configured to increase overall beam selection efficiency across the first network node and the second network node; and
transmit, to the first network node and the second network node, the policy.

27. The controller of claim 26, wherein the controller is further configured to train the ML model using the first network node data set and the second network node data set in conjunction comprises using one of: RL or an ADMM optimization algorithm.

28. The controller of claim 26, wherein the controller is further configured to:
receive from the first network node a plurality of first network node data sets, and
receive from the second network node a plurality of second network node data sets.

29. The controller of claim 28, wherein the initial first network node state of each of the plurality of first network node data sets corresponds to the resulting first network node state of the following first network node data set.

30. The controller of claim 28, wherein the plurality of first network node data sets comprises 10 first network node data sets and wherein the plurality of second network node data sets comprises 10 second network node data sets.

31. The controller of claim 26, wherein each of the first and second network node data sets comprises a time stamp.

32. The controller of claim 31, wherein the controller is further configured to:
train a first ML model associated with a first time stamp to generate a first policy, and
train a second ML model associated with a second time stamp to generate a second policy.

33. The controller of claim 26, wherein the controller is further configured to train the ML model by calculating a true action-value, Q-Value.

34. The controller of claim 33, wherein the Q-Value comprises a first weighting function associated with the first network node and a second weighting function associated with the second network node.

35. The controller of claim 34, where the first weighting function and/or the second weighting function are associated with one or more of: the maximum number of user equipments, UEs, that can be connected to the respective network node, the number of active UEs connected to the respective network node, the number of dormant and/or idle UEs connected to the respective network node, and/or the number of inactive UEs connected to the respective network node.

36. The controller of claim 26, wherein the controller is further configured to train the ML model by using the equation
$$δ = R + γ u ( {S}^{′} , w ) - u ( S , w )$$
where δ is the loss function for the communication network, R is the reward function for the communication network, S is an initial state of the communication network, S′ is a resulting state of the communication network, u(S,w) is the estimation of the Q-value for state S, γ is a weighting function, and w are the parameters used to quantify S.

37. The controller of claim 26, wherein the controller is further configured to repeat the steps of the method to form an iterative ML method.

38. The controller of claim 37, wherein the iterative ML method is ended when ML model reaches a stable state.

39. The controller of claim 26, wherein increasing overall beam selection efficiency comprises one or more of: maximizing throughput, minimizing latency, and reducing energy and/or resource consumption

40. The controller of claim 26, wherein the first network node is configured to control a first beam selection based on the policy and the second network node is configured to control a second beam selection based on the policy.

41. The controller of claim 32, wherein the first network node and second network node are further configured to:
store the first policy and the second policy; and
control the first and second beam selection respectively using the first policy and the second policy in accordance with the time stamps of the first policy and the second policy.

42. The controller of claim 41, wherein the first network node and the second network node are further configured to cache the first policy and the second policy.

43. The controller of claim 40, wherein the first network node is further configured to train a first network node ML model using the first network node data, and wherein the second network node is further configured to train a second network node ML model using the second network node data.

44. The controller of claim 43, wherein the first network node and the second network node are configured to train each respective network node ML model using the following equation
$$x = mean ( - δ * log ( π ( α / s ) ) ,$$
where x is a training function. δ is the loss function for the communication network, α is the respective network node action, s is the respective network node state, π is a probability for the respective network node action α to occur when the respective network node is in the respective network node state s.

45. The controller of claim 43, wherein the first network node and the second network node are configured to train each respective network node ML model using the calculation of a reward function.

46-51. (canceled)
